(19) United States
(12) Patent Application Publication
(10) Pub. No.: US 2024/0413558 A1
(43) Pub. Date: Dec. 12, 2024

(54) ELECTRICAL CONNECTOR WITH AN IMPROVED TONGUE PORTION

(71) Applicants: FUDING PRECISION COMPONENTS (SHENZHEN) CO., LTD., Shenzhen (CN); FOXCONN INTERCONNECT TECHNOLOGY LIMITED, Grand Cayman (KY)

(72) Inventor: HONG-JING LUO, Shenzhen (CN)

(21) Appl. No.: 18/734,264

(22) Filed: Jun. 5, 2024

(30) Foreign Application Priority Data
Jun. 7, 2023 (CN) 202310671580.6

(51) Int. Cl. H01R 13/08; H01R 13/504; H01R 13/642; H01R 13/652; H01R 24/64

(52) U.S. Cl. CPC H01R 13/08; H01R 13/504; H01R 13/642; H01R 13/652; H01R 24/64

(57) ABSTRACT

An electrical connector includes: a longitudinal insulating housing having a base portion and a tongue portion extending forwardly from the base portion; a row of first terminals and a row of second terminals located at two opposite sides of the tongue portion respectively, each row of the first terminals and the second terminals including plural signal terminals and plural grounding terminals; and a grounding member located between the row of first terminals and the row of second terminals, wherein the grounding member comprises a main portion and plural first contacting portions protruding from the main portion and contacting with corresponding grounding terminals of the first terminals, and the grounding member is embedded in the insulating housing by injection molding.

### BACKGROUND OF THE INVENTION

### Field of the Invention

The present invention relates to an electrical connector, which transmits high frequency signal.

### Description of Related Arts

U.S. Publication No. 2021/0044060A discloses a high frequency electrical connector, which includes a tongue, two rows of terminals retained at two sides of the tongue, and a grounding bar. The tongue has a receiving groove, and the grounding bar is forwardly assembled into the tongue from a rear side thereof. Since a thickness of the tongue is limited, the receiving groove in the tongue weakens structural strength of the tongue.

Therefore, it is desired to provide an electrical connector with an improved tongue portion.

### SUMMARY OF THE INVENTION

An object of the present invention is to provide an electrical connector with an improved tongue portion.

To achieve the above object, an electrical connector comprises: a longitudinal insulating housing having a base portion and a tongue portion extending forwardly from the base portion; a row of first terminals and a row of second terminals located at two opposite sides of the tongue portion respectively, each row of the first terminals and the second terminals comprising plural signal terminals and plural grounding terminals; and a grounding member located between the row of first terminals and the row of second terminals; wherein the grounding member comprises a main portion and plural first contacting portions protruding from the main portion and contacting with corresponding grounding terminals of the first terminals, and the grounding member is embedded in the insulating housing by injection molding.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of a first embodiment of this present invention;

FIG. 2 is an exploded perspective view of the electrical connector of FIG. 1, wherein a second insulator is separated from a first insulator;

FIG. 3 is a partial top view of the electrical connector of FIG. 1;

FIG. 4 is a partial bottom view of the electrical connector of FIG. 1;

FIG. 5 is a further exploded perspective view of the electrical connector of FIG. 2 with the second insulator being removed away;

FIG. 6 is another exploded perspective view of the electrical connector of FIG. 5;

FIG. 7 is an exploded perspective view of the electrical connector without the second insulator of FIG. 2, wherein a grounding member with a strip is separated from the first insulator;

FIG. 8 is a cross-sectional view of the electrical connector along line A-A of FIG. 1;

FIG. 9 is a perspective view of an electrical connector of a second embodiment of this present invention;

FIG. 10 is a partial top view of the electrical connector of FIG. 9;

FIG. 11 is a partial bottom view of the electrical connector of FIG. 9;

FIG. 12 is another perspective view of the electrical connector of FIG. 9, wherein the second insulator is separated from the first insulator;

FIG. 13 is a further exploded perspective view of the electrical connector of FIG. 12 with the second insulator being removed;

FIG. 14 is another exploded perspective view of the electrical connection of FIG. 13;

FIG. 15 is a perspective view of the electrical connector of FIG. 12, wherein the grounding member connecting with the strip is separated from the first insulator; and

FIG. 16 a cross-sectional view of the electrical connector along line B-B of FIG. 9.

### DETAILED DESCRIPTION OF THE PREFERRED EMBODIMENT

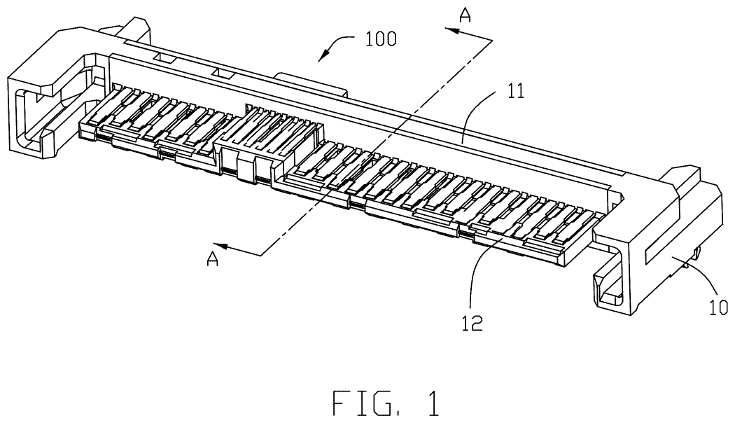

Referring to FIG. 1, an electrical connector with SFF-8639 transmission interface is illustrated. In this embodiment, the electrical connector is a plug connector 100 and is adapted for transmitting high speed signals with transmission bandwidth up to 128 GB/s by adopting the latest generation PCIe 5.0 transmission protocol.

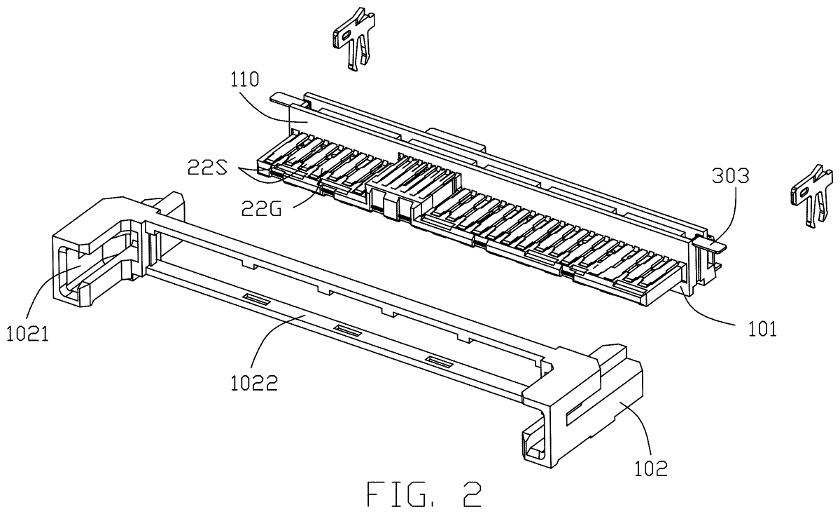

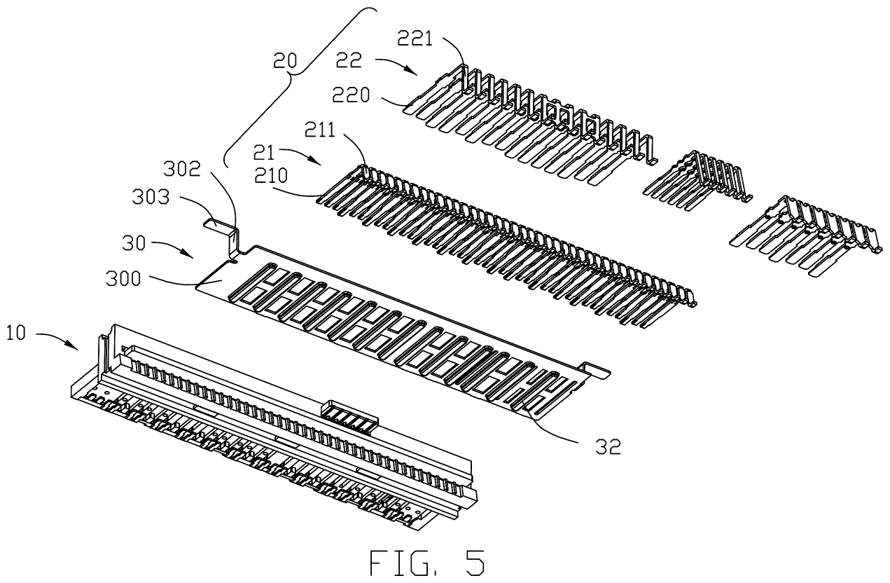

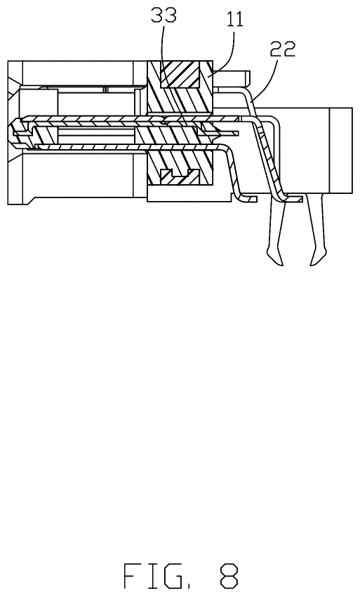

Referring to FIGS. 1-2 and 5, the plug connector 100 comprises an insulating housing 10, plural terminals 20 and a grounding member 30, the insulating housing 10 comprises a longitudinal base portion 11, a tongue portion 12 extending forward from the base portion 11. The terminals 20 include a row of first terminals 21 and a row of second terminals 22 which comprises plural signals terminals 21S, 22S and plural grounding terminals 21G, 22G. Each terminal 20 comprises a flat portion 210, 220 and a tail portion 211, 221. The grounding member 30 is embedded in insulating housing 10 by injection molding. The grounding member 30 comprises a plate-shaped main portion 300 and plural first contacting portions 32 protruding from the main portion 300 toward the grounding terminals 21G of the first terminals 21. The grounding member 30 is embedded in the tongue portion 12 by injection molding, which can effectively strengthen the tongue portion 12, making the tongue portion 12 more reliable and durable. Combining with FIG. 8, the first contacting portion 32 is in a form of a convex rib extending from the base portion 11 to a front end of the tongue portion 12, thus, a larger contacting area is provided between the first contacting portion 32 and the tongue portion 12 for making a better and stable connecting between them.

In order to enable the grounding member 30 to be better retained in the tongue portion 12, the grounding member 30 is provided with two ears 301 at two ends thereof, which are embedded in the insulating housing 10. The insulating housing 10 comprises a first insulator 101 with the tongue portion 12 and a second insulator 102 surrounding the first insulator 101. The first insulator 101 further comprises an inner base portion 110 behind the tongue portion 12 which is a part of the base portion 11. The second insulator 102 comprises a frame portion 1022 surrounding the inner base portion 110 and two guiding portions 102 at two ends of the frame portion 1022. Each guiding portion 102 has a guiding groove 1021 extending along a front-rear direction of the connector. A receptacle connector can slide along the guiding groove 1021 to mate with the plug connector 100. In this embodiment, the first insulator 101 and the second insulator 102 are formed and fixed together by double shot injection (two-shot injection). In other embodiments, the second insulator can be formed at an outside of the first insulator 101 through a secondary injection molding, that is, molding the first insulator firstly and then molding the second insulator at an outside of the first insulator. The first insulator 101 and the second insulator 102 can also be fixed together after they are respectively formed. Each ear 301 comprises a vertical portion 302 embedded in the inner base portion 110 of the first insulator 101 and a horizontal portion 303 embedded in the second insulator 102.

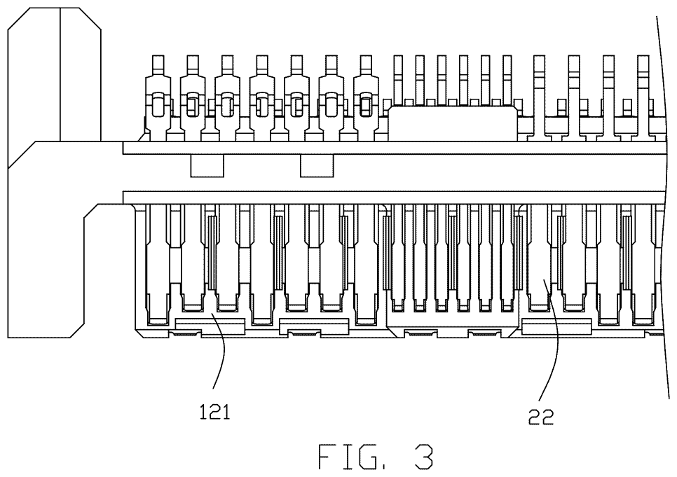

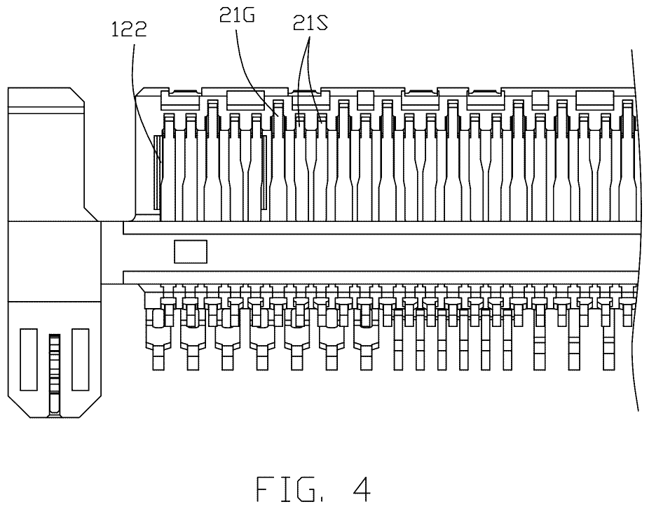

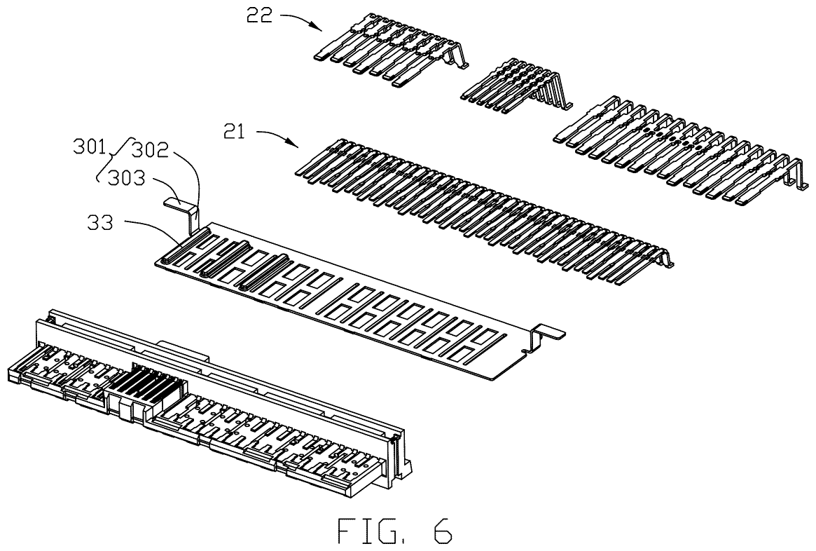

Referring to FIG. 3, a side of the tongue portion 12 where the second terminals located is provided with plural first positioning grooves 121 through which a positioning mold (not shown) passes to press the grounding member 30 toward another side where the first terminals 21 located during injection molding. Referring to FIGS. 4, 6 and 7, the grounding member 30 has plural second contacting portions 33 protruding from the main portion 300 toward the grounding terminals 22G of the second terminals 22, and the second contacting portions 33 contact with the grounding terminals 22G. Similar to the first contacting portion 32, the second contacting portion 33 is a convex rib which extends from the base portion 11 to the front end of the tongue portion 12. A side of the tongue portion 12 where the first terminals located has plural second positioning grooves 122 through which another positioning mold (not shown) passes to press the grounding member 30 toward the side where the second terminals 21 located during injection molding. The main portion 300 has a plurality of slots 34 at positions corresponding to the signal terminals 21S, 22S of the first terminals 21 or the second terminals 22.

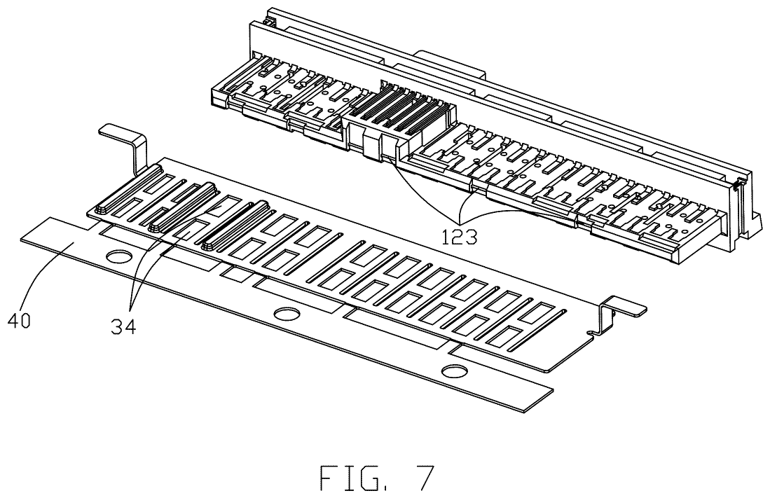

Referring to FIG. 7, the tongue portion is provided with plural openings 123 at a front end thereof, the strip 40 in front of the tongue portion is bent and separated from the grounding member 30, leaving strip-cutting faces of the grounding member exposed to the opening 123. In traditional way, the grounding member is inserted into a receiving groove of the tongue portion from a rear end thereof, thus, the strip is left behind the tongue portion 12 and is hard to bend and separate from the grounding member due to the tail portions of the terminals after the terminals are inserted. In traditional way, the receiving groove can not be opened through the front face of the tongue portion as the receiving groove is longitudinally continuous. So the way of fixing the grounding member 30 with the tongue portion 12 by injection molding in this present invention can not only improve the strength of the tongue portion 12, but also enable the strip 40 to be easily separated from the tongue portion. A method of making the plug connector 100 in this embodiment comprises steps of: providing a grounding member 30 with the strip 40; molding insulating housing 10 around the grounding member 30 connecting with the strip 40; and inserting the first row of terminals 21 and the second row of terminals 22 at two sides of the insulating housing 10. Before inserting the first row of terminals 21 and the second row of terminals 22 at two sides of the insulating housing 10, move away the strip 40 from the grounding member 30 embedded in the insulating housing 10. In other embodiments, the strip 40 can be moved away after inserting the first row of terminals 21 and the second row of terminals 22 at two sides of the insulating housing 10. The grounding member 30 is metallic, the first contacting portion 32 is of a convex rib formed by punching the main portion 300 toward its side where the first terminals 21 are located. The first contacting portions are in a form of a longwise rib which is united with the main portion without any slits.

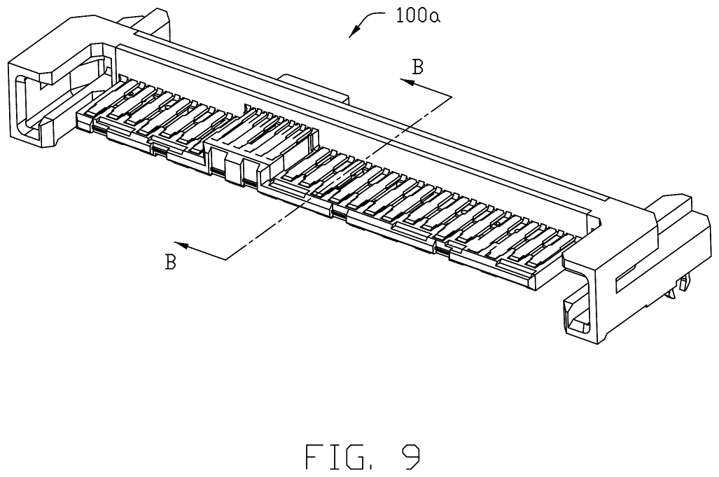

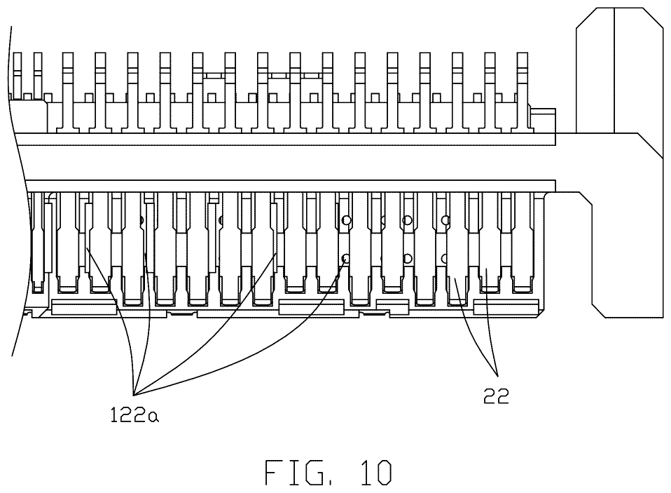

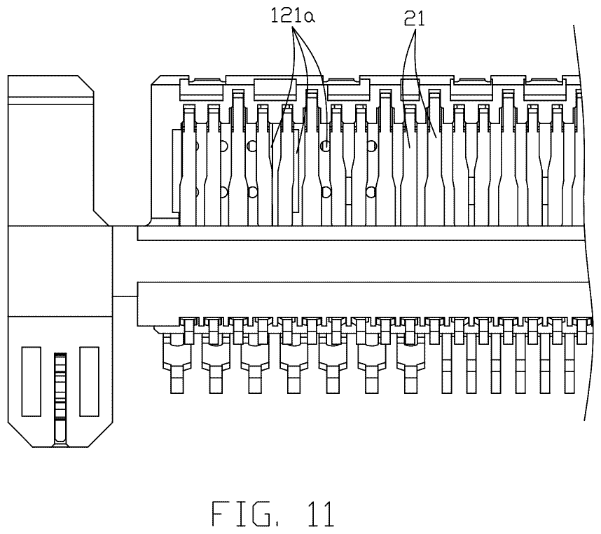

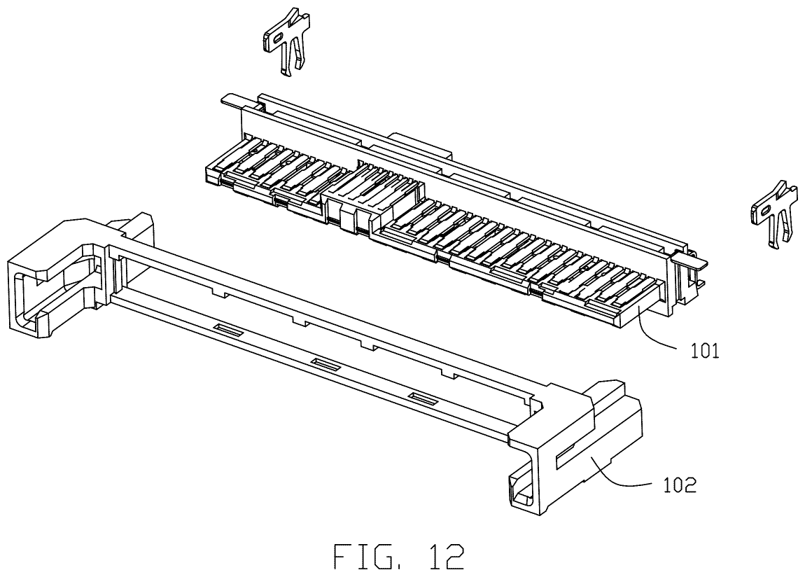

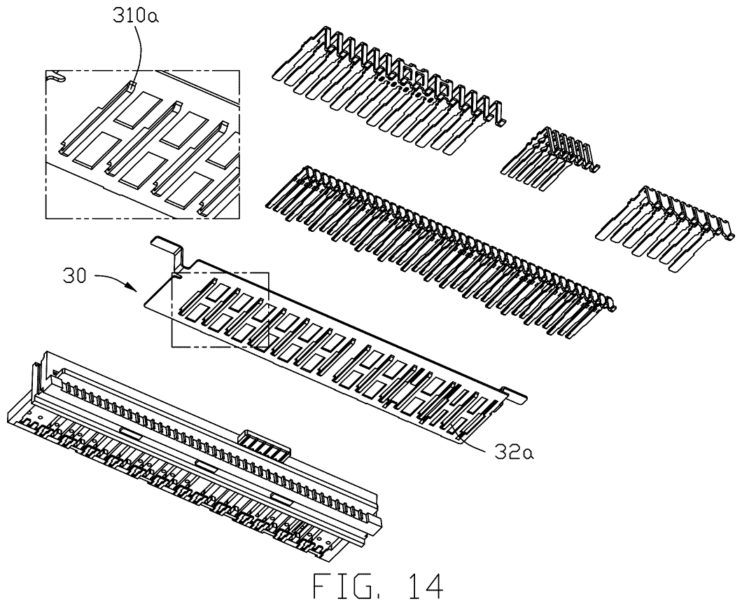

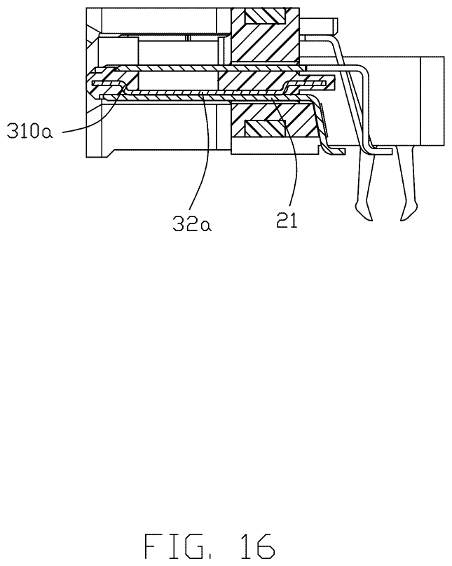

Referring to FIGS. 9-16, a plug connector 100a in a second embodiment which is roughly the same as that in the first embodiment, is illustrated. In this embodiment, the same structures are labeled with same symbols and are not described in detail again, only the main differences are described below.

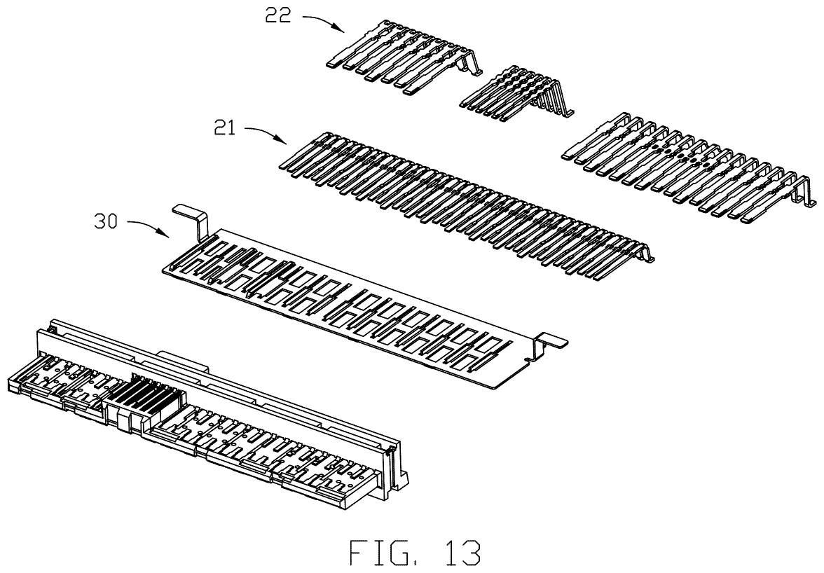

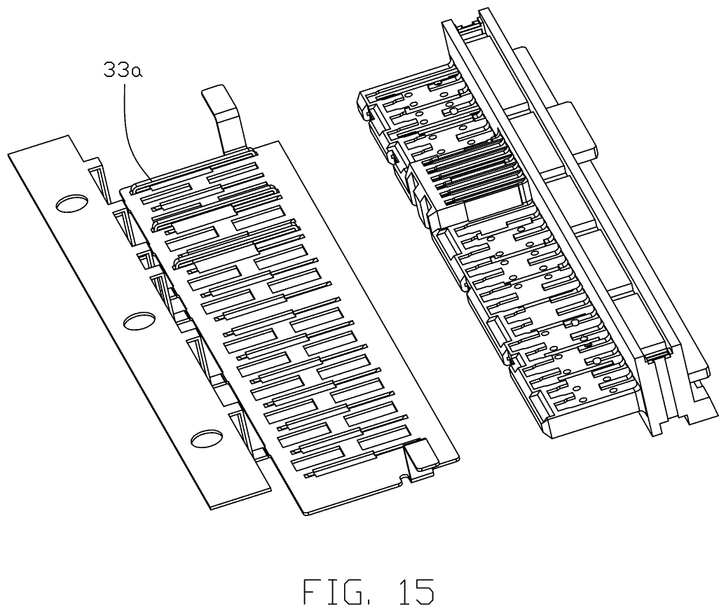

Referring to FIGS. 9-11, the tongue portion 12 further comprises positioning hole except for the first positioning grooves 121a and the second positioning grooves 122a. Referring to FIGS. 13 and 15, the first contacting portion 32a and the second contacting portion 33a are different from the first contacting portion 32 and the second contacting portion 33 in the first embodiment. The grounding member 30 is metallic too. The first contacting portion 32a and the second contacting portion 33a are in a form of punching strips. The punching strip is formed by punching from the main portion. Two long opposite sides of the punching strip are cut from the main portion 300. Two opposite ends of the punching strip are connected with the main portion 300 by bending portion 310a.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
a longitudinal insulating housing having a base portion and a tongue portion extending forwardly from the base portion;
a row of first terminals and a row of second terminals located at two opposite sides of the tongue portion respectively, each row of the first terminals and the second terminals comprising plural signal terminals and plural grounding terminals; and
a grounding member located between the row of first terminals and the row of second terminals;
wherein the grounding member comprises a main portion and plural first contacting portions protruding from the main portion and contacting with corresponding grounding terminals of the first terminals, and the grounding member is embedded in the insulating housing by injection molding.

2. The electrical connector as claimed in claim 1, wherein the row of first terminals are exposed to a first side of the tongue portion, a second side opposite to the first side of the tongue portion has plural first positioning grooves for a first positioning mold to press the grounding member toward the first side of the mating portion and fix the grounding member in an injection molding process.

3. The electrical connector as claimed in claim 2, wherein the grounding member comprises plural second contacting portions protruding from the main portion, the second contacting portions contact with corresponding grounding terminals of the second terminals.

4. The electrical connector as claimed in claim 3, wherein the first side of the mating portion has plural second positioning grooves for a second positioning mold to press the grounding member toward the second side of the mating portion and further fix the grounding member.

5. The electrical connector as claimed in claim 1, wherein the grounding member comprises two ears embedded in two opposite ends of the base portion, the insulating housing comprises a first insulator with the tongue portion and a second insulator surrounding the first insulator, each ear comprises a vertical portion extending from the main portion and a horizontal portion extending from the vertical portion, and the vertical portions are embedded in the first insulator and the horizontal portions are embedded in the second insulator.

6. The electrical connector as claimed in claim 1, wherein each terminal comprises a flat portion exposed to the tongue portion and a tail portion bending from the flat portion and extending downwardly from the base portion, the first contacting portion is of a convex rib extending forwardly, and a rear end of the convex rib is near the base portion and a front end of the convex rib is near a front end of the tongue portion.

7. The electrical connector as claimed in claim 6, wherein the grounding member comprises plural second contacting portions protruding from the main portion, the second contacting portions contact with corresponding grounding terminals of the second terminals, and the second contacting portion is of a convex rib, and the grounding member has a plurality of slots at positions corresponding to the signal terminals of the first terminals or the second terminals.

8. The electrical connector as claimed in claim 7, wherein the grounding member is metallic, and the convex rib is formed by punching from the main portion.

9. The electrical connector as claimed in claim 1, wherein the grounding member is metallic, the first contacting portion is formed by punching from the main portion, and opposite long sides of each first contacting portion are separated from the main portion and opposite ends of each first contacting portions are united with the main portion.

10. The electrical connector as claimed in claim 1, wherein the tongue portion has plural openings at a front end thereof, and plural strip-connecting portions are exposed to the openings.

11. An electrical connector comprising:
a longitudinal insulating housing comprises a base portion and a tongue portion extending from the base portion, the tongue portion having a first side and a second side opposite to the first side;
a row of first terminals located on the first side of the tongue portion and comprising plural signal terminals and plural grounding terminals; and
a grounding member retained in the insulating housing, the grounding member comprising a main portion and plural first contacting portions protruding from the main portion and connecting with corresponding grounding terminals of the row of first terminals;
wherein the grounding member is embedded in the insulating housing and the tongue portion has plural mold-positioning grooves.

12. The electrical connector as claimed in claim 11, wherein the insulating housing is injection molded around the grounding member.

13. The electrical connector as claimed in claim 11, wherein the first contacting portions are in a form of a longwise rib, and the longwise rib is united with the main portion without any slits.

14. The electrical connector as claimed in claim 11, wherein the first contacting portions are in a form of a longwise rib, and the longwise rib is united with the mating portion with two opposite long slits.

15. The electrical connector as claimed in claim 11, wherein the grounding member has strip-cutting edges exposed to a front end of the tongue portion.

16. The electrical connector as claimed in claim 12, wherein a first insulator is retained around the grounding member by a first injection molding process and a second insulator is retained around the first insulator by a second injection molding process to form the insulating housing with the grounding member.

17. A method of making an electrical connector, comprising steps of:
providing a grounding member with a strip;
injection molding an insulating housing with the grounding member to have a base portion and a tongue portion with terminal grooves at opposite sides thereof; and
inserting a first row of terminals and a second row of terminals into the terminal grooves.
